(19) United States
(12) Patent Application Publication
(10) Pub. No.: US 2013/0176497 A1
(43) Pub. Date: Jul. 11, 2013

(54) VIDEO PROJECTION APPARATUS

(71) Applicants: Yoshifumi KAWAI, Kanagawa (JP); Reiji Yukumoto, Kanagawa (JP); Ryo Iwasaki, Kanagawa (JP); Hiroshi Maeda, Kanagawa (JP)

(72) Inventors: Yoshifumi KAWAI, Kanagawa (JP); Reiji Yukumoto, Kanagawa (JP); Ryo Iwasaki, Kanagawa (JP); Hiroshi Maeda, Kanagawa (JP)

(21) Appl. No.: 13/724,243

(22) Filed: Dec. 21, 2012

(30) Foreign Application Priority Data
Jan. 6, 2012 (JP) 2012-001279

(51) Int. Cl. H04N 5/268

(52) U.S. Cl. CPC H04N 5/268
USPC 348/705

(57) ABSTRACT

A video projection apparatus includes a plurality of video input units; a video projection unit that projects video based on video data input from each of the plurality of video input units on a projection surface thereof; a video switching unit that switches to any one of the video input units as an input source of video data to be input to the video projection unit; and a video switching control unit that receives a projection request of the video data input from each of the video input units, reserves projection of each of the received projection requests in an order according to a predetermined rule, and causes the video switching unit to sequentially switch among the video input units, which respectively correspond to the received projection requests, as the input source in the order.

### CROSS-REFERENCE TO RELATED APPLICATIONS

The present application claims priority to and incorporates by reference the entire contents of Japanese Patent Application No. 2012-001279 filed in Japan on Jan. 6, 2012.

### BACKGROUND OF THE INVENTION

1. Field of the Invention

The present invention relates to a video projection apparatus including a projector which projects video based on video data on a projection surface.

2. Description of the Related Art

A video projection apparatus (also called “image projection apparatus”), such as a projector has been used which projects video based on video data (also called “image data”) containing still images and moving images on a projection surface such as a screen.

In such a video projection apparatus, a plurality of input units is provided to input video data, and the following techniques are known: a technique which switches among video data by user's switching operation performed with respect to the video projection apparatus; a technique which switches among video data, based on a request from an information processing apparatus such as a personal computer (PC) connected via a network; and a technique which switches among video data in a manner that the video projection apparatus itself automatically detects the presence of input of the video data.

In the related art, there is a video projection apparatus (for example, refer to Japanese Patent Application Laid-open No. 2008-89886) which receives a video output request signal from each of a plurality of client equipment via wireless communication, determines whether the received video output request signal is acceptable, transmits, when it is acceptable, a reception permission signal to the client equipment which has transmitted the video output request signal which is acceptable and performs a projection display of video based on video data received from the client equipment, and switches, if an interruption has been permitted in advance, to a projection display of video based on video data received later during a projection display of video based on video data received earlier.

However, the above-described projection apparatus according to the related art has a problem that because switching among video data or interruption of video data is permitted by a request made through user's operation or by detection of the presence of an input signal, for example, when switching to a requested projection during a projection of video data with a higher priority is refused or when video data is not constantly output from the client equipment whose request has been refused, even though the video projection apparatus has entered a state in which the projection apparatus can perform a projection, the projection cannot be started unless a request of projection is made again.

Therefore, there is a need for a video projection apparatus capable of starting a projection of each of the plurality of requests when the apparatus accepts the requests and then enters a state in which the apparatus can perform a projection.

### SUMMARY OF THE INVENTION

According to an embodiment, there is provided a video projection apparatus includes a plurality of video input units; a video projection unit that projects video based on video data input from each of the plurality of video input units on a projection surface thereof; a video switching unit that switches to any one of the video input units as an input source of video data to be input to the video projection unit; and a video switching control unit that receives a projection request of the video data input from each of the video input units, reserves projection of each of the received projection requests in an order according to a predetermined rule, and causes the video switching unit to sequentially switch among the video input units, which respectively correspond to the received projection requests, as the input source in the order.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example of an internal configuration of a projector 1 illustrated in FIG. 2;

FIG. 2 is a diagram illustrating an example of a configuration of a projection system which is one embodiment of the invention;

FIG. 3 is a diagram illustrating an example of a format of a reservation slip;

FIG. 4 is a diagram illustrating an example of a format of a reservation table;

FIG. 5 is an explanatory diagram of a life cycle of a reservation slip of an external storage 5 illustrated in FIG. 1;

FIG. 6 is an explanatory diagram of a life cycle of each of reservation slips of PCs 2 and 3 illustrated in FIG. 1;

FIG. 7 is a flowchart illustrating an operation from start to end of a reservation that the PC 2 has made with respect to the projector 1 illustrated in FIG. 1;

FIG. 8 is a flowchart illustrating an operation from start to end of a reservation of the PC 2 in a video projection request management unit 10 of the projector 1 illustrated in FIG. 1;

FIG. 9 is a diagram illustrating a sequence of a projection operation of the projector 1, the PC 2, and the PC 3 of FIG. 1;

FIG. 10 is a diagram illustrating an example of the data contents of a reservation table retained by the video projection request management unit 10 of the projector 1 of FIG. 1;

FIG. 11 is a diagram illustrating another example of the data contents of a reservation table also retained by the video projection request management unit 10 of FIG. 1;

FIG. 12 is a diagram illustrating a further example of the data contents of a reservation table also retained by the video projection request management unit 10 of FIG. 1;

FIG. 13 is a diagram illustrating a yet further example of the data contents of a reservation table also retained by the video projection request management unit 10 of FIG. 1; and

FIG. 14 is a diagram illustrating a yet further example of the data contents of a reservation table also retained by the video projection request management unit 10 of FIG. 1.

### DETAILED DESCRIPTION OF THE PREFERRED EMBODIMENTS

Hereinafter, embodiments to implement the invention will be described in detail with reference to the drawings.

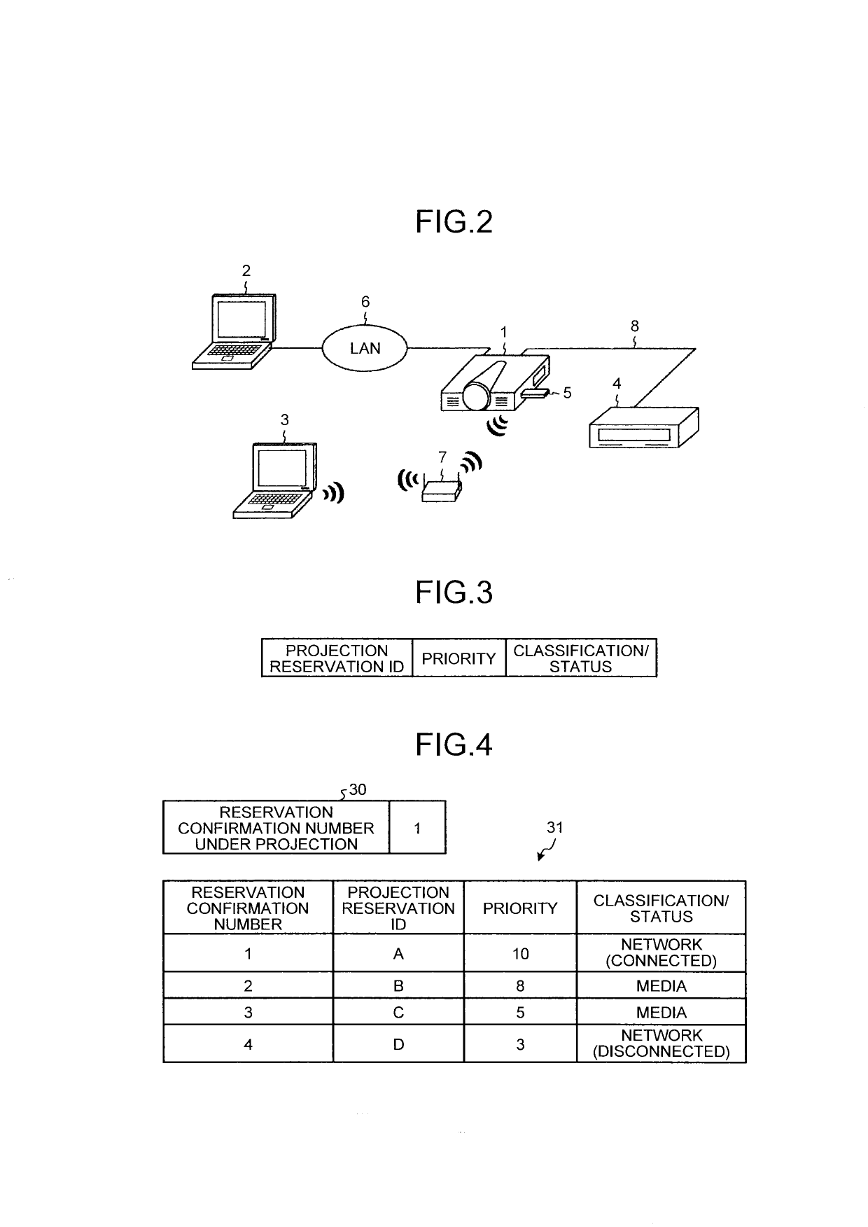

FIG. 2 is a diagram illustrating an example of a configuration of a projection system which is one embodiment of the invention.

The projection system includes a projector 1 which is an example of a video projection apparatus (also called an “image projection apparatus”), personal computers (PCs) 2 and 3, a video output apparatus 4 such as an optical disc recording/reproducing apparatus, and an external storage 5 such as flash memory.

The projector 1 projects video based on projection data input from the PC 2 or 3, the video output apparatus 4, or the external storage 5 on a projection surface such as a screen.

The PC 2 can perform wired data communication with the projector 1 via a Local Area Network (LAN) 6.

The PC 3 can perform data perform wireless communication of video data or the like with the projector 1 via a wireless access point (wireless AP) 7.

The video output apparatus 4 is connected to a video input terminal of the projector 1 such as an HDMI (High-Definition Multimedia Interface) terminal, an RGB terminal, and a video terminal via a cable 8 and can perform input/output of data with respect to the projector 1.

The external storage 5 is directly connected to a connection terminal, for example, a USB (Universal Serial Bus) terminal, of the projector 1, and can perform input/output of data with respect to the projector 1.

The wireless AP 7 is a communication apparatus which mediates wireless data communications between the projector 1 and the PC 3.

In the projection system configured in this way, the projector 1 is shared by the PCs 2 and 3, the video output apparatus 4, and the external storage 5, so that video on a screen of each of the PCs 2 and 3, and video retained by each of the PCs 2 and 3, the video output apparatus 4, and the external storage 5 can be projected using the projector 1.

The configuration example of the projection system of FIG. 2 is just an example, and other PCs, video output apparatuses, or external storages can be further connected.

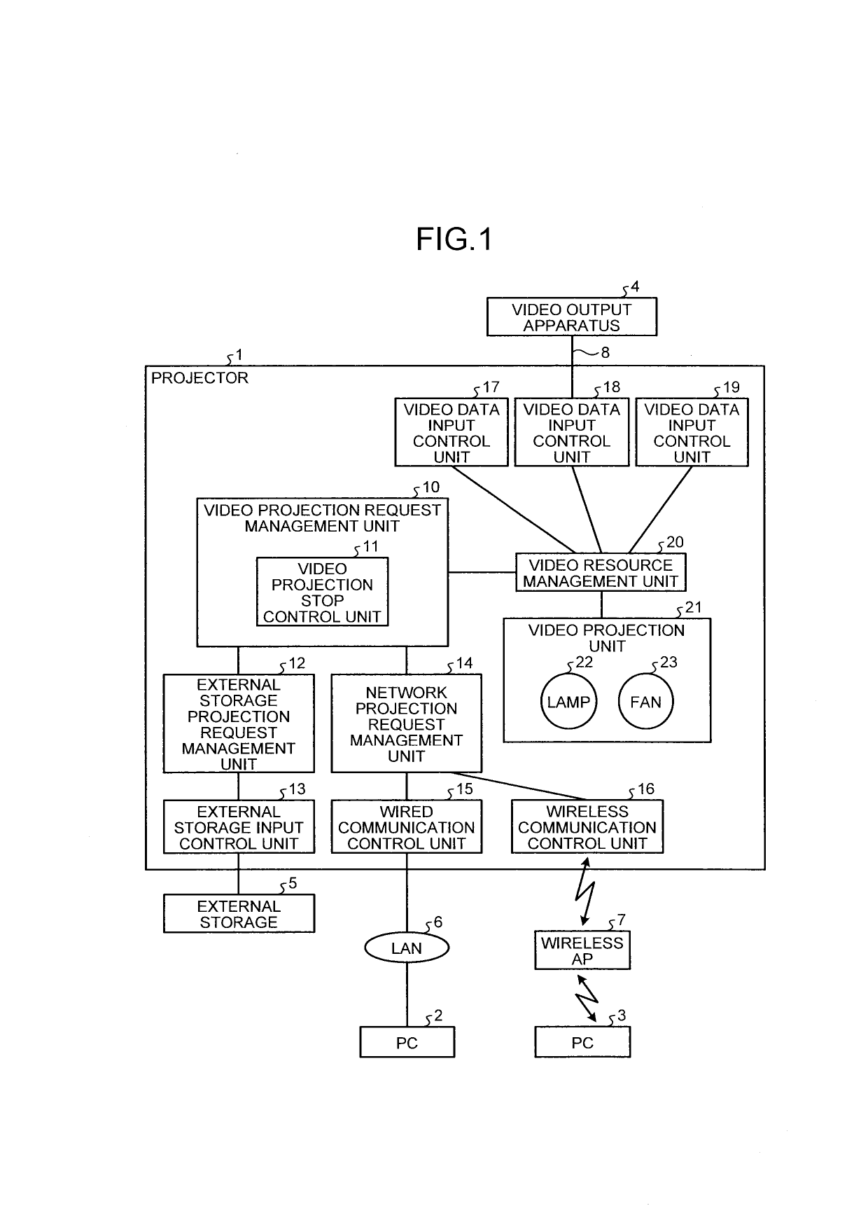

FIG. 1 is a block diagram illustrating an example of an internal configuration of the projector 1 illustrated in FIG. 2.

The projector 1 includes a video projection request management unit 10, an external storage projection request management unit 12, an external storage input control unit 13, a network projection request management unit 14, a wired communication control unit 15, a wireless communication control unit 16, video data input control units 17 to 19, a video resource management unit 20, and a video projection unit 21.

In addition, the video projection request management unit 10 includes a video projection stop control unit 11. The video projection unit 21 includes a lamp 22 and a fan 23.

The video projection request management unit 10 gathers reservations of projection requests of video data from the PCs 2 and 3, the video output apparatus 4, and the external storage 5, and asks the video resource management unit 20 to switch the input source of video data to be projected, so as to sequentially perform the projections of each of the reserved projection requests.

Specifically, the video projection request management unit 10 accepts projection requests of video data, which is input to the external storage projection management unit 12, the network projection request management unit 14, and the video data input control units 17 to 19 from the PCs 2 and 3, the video output apparatus 4, and the external storage 5, respectively; reserves projections of the respective accepted projection requests in order according to a predetermined rule; and causes the video resource management unit 20 to sequentially switch among the external storage projection request management unit 12, the network projection request management unit 14, and the video data input control units 17 to 19, as the input sources of video data whose projection requests have been accepted, in order in which the respective projection requests are reserved. That is, the video projection request management unit 10 functions as a video switching control unit.

The video projection stop control unit 11 performs control of causing the input source of video data to stop inputting the video data, based on instructions from the video projection request management unit 10.

That is, the video projection stop control unit 11 functions as a unit for causing a video input unit, which is the input source of the video data being currently projected, to stop inputting the video data.

The external storage input control unit 13 controls reading of video data recorded in the external storage 5, and writing of video data to the external storage 5.

That is, the external storage input control unit 13 corresponds to one of the plurality of video input units.

The external storage projection request management unit 12 sends the projection request of the video data stored in the external storage 5 to the video projection request management unit 10, in response to a user's request which is input from the input unit (not illustrated) of the projector 1. In addition, when a projection available notice is received from the video projection request management unit 10, it is determined whether to start a projection or not.

The wired communication control unit 15 controls data communications with the PC 2 via the LAN 6 which is connected thereto in a wired manner.

The wireless communication control unit 16 controls data communications with the wireless AP 7, and controls data communications with the PC 3 via the wireless AP 7.

That is, each of the wired communication control unit 15 and the wireless communication control unit 16 corresponds to a video input unit.

The network projection request management unit 14 sends a projection request of video data from the PC 2 or the PC 3 to the video projection request management unit 10.

The video data input control units 17 to 19 control the input of the video data output from the connected video output apparatus 4. FIG. 1 illustrates a case where the video output apparatus 4 is connected to the video data input control unit 18 and no apparatus is connected to the video data input control units 17 and 19. Other video output apparatuses can be connected to the video data input control units 17 and 19, respectively.

That is, each of the video data input control units 17 to 19 correspond to a video input unit.

The video resource management unit 20 switches, in response to the instruction supplied from the video projection request management unit 10, to any one of the external storage input control unit 13, the wired communication control unit 15, the wireless communication control unit 16, and the video data input control units 17 to 19 as the input source of video data, and outputs the video data which has been input to the input source to the video projection unit 21.

That is, the video resource management unit 20 functions as a video switching unit which switches to any one of the external storage input control unit 13, the wired communication control unit 15, the wireless communication control unit 16, and the video data input control units 17 to 19 as the input source of the video data with respect to the video projection unit 21.

The video projection unit 21 projects video based on the input video data with a lamp 22. The fan 23 is provided to cool down the inside of the video projection unit 21.

That is, the video projection unit 21 functions as a video projection unit which projects video based on video data which has been input from any one of the external storage input control unit 13, the wired communication control unit 15, the wireless communication control unit 16, and the video data input control units 17 to 19, on a projection surface.

Next, by referring to FIG. 3, a reservation slip used at the time of reserving a projection request in the video projection request management unit 10 illustrated in FIG. 1 is described.

FIG. 3 is a diagram illustrating an example of a format of the reservation slip.

The video projection request management unit 10 of FIG. 1 retains the reservation table in advance; creates a reservation slip of a projection request when the projection request is received; and registers the reservation slips into the reservation table in order according to a predetermined rule so that the reservation slips are arranged in order according to the predetermined rule, for example, in order of reception number of each projection request or in order of priority given to each projection request, from a projection request with a high priority to a projection request with a low priority.

As illustrated in FIG. 3, the reservation slip includes a projection reservation ID, a priority, and each item of a classification/status.

The projection reservation ID is identification information (ID) to identify the reservation slip.

The priority is a numerical value which represents the priority of the reservation, and it is assumed that a larger number represents a higher priority for convenience in description in the present embodiment.

The classification is information to identify a projection request source, and, in the present embodiment, the external storage 5 and the video output apparatus 4 of FIG. 1 are assumed to be “media”, and the PCs 2 and 3 of FIG. 1 are assumed to be “networks”.

The status is information to indicate a resource occupation state, and includes information indicating whether projection of the projection request of the reservation slip is being currently projected or not. In addition, the status includes information indicating whether video data has been input to the input source or not, or whether the network is connected or disconnected.

Next, by referring to FIG. 4, the reservation table retained by the video projection request management unit 10 illustrated in FIG. 1 is described.

FIG. 4 is a diagram illustrating an example of a format of the reservation table.

The reservation table has a field 30 to store a reservation confirmation number of the projection request being currently projected and a field 31 in which the reservation slips are arranged in execution order.

The field 30 is a field for the video projection request management unit 10 of FIG. 1 to store “the reservation confirmation number under projection”, and FIG. 4 illustrates an example where “1” is stored as the confirmation number.

The field 31 is a field used by the video projection request management unit 10 of FIG. 1 for reserving the reservation slips of the accepted projection requests in order according to a predetermined rule, and the reservation slips are registered such that projection is executed in order from the reservation confirmation number “1”.

In FIG. 4, the reservation slip of the projection reservation ID “A” is registered with the reservation confirmation number “1” which will be executed for the first time. The projection reservation ID “A” corresponds to the PC 2 of FIG. 1, for example.

The reservation slip of the projection reservation ID “B” is registered with reservation confirmation number “2”. The projection reservation ID “B” corresponds to the video output apparatus 4 of FIG. 1, for example.

The reservation slip of projection reservation ID “C” is registered with reservation confirmation number “3”. The projection reservation ID “C” corresponds to the external storage 5 of FIG. 1, for example.

The reservation slip of projection reservation ID “D” is registered with reservation confirmation number “4”. The projection reservation ID “D” corresponds to the PC 3 of FIG. 1, for example.

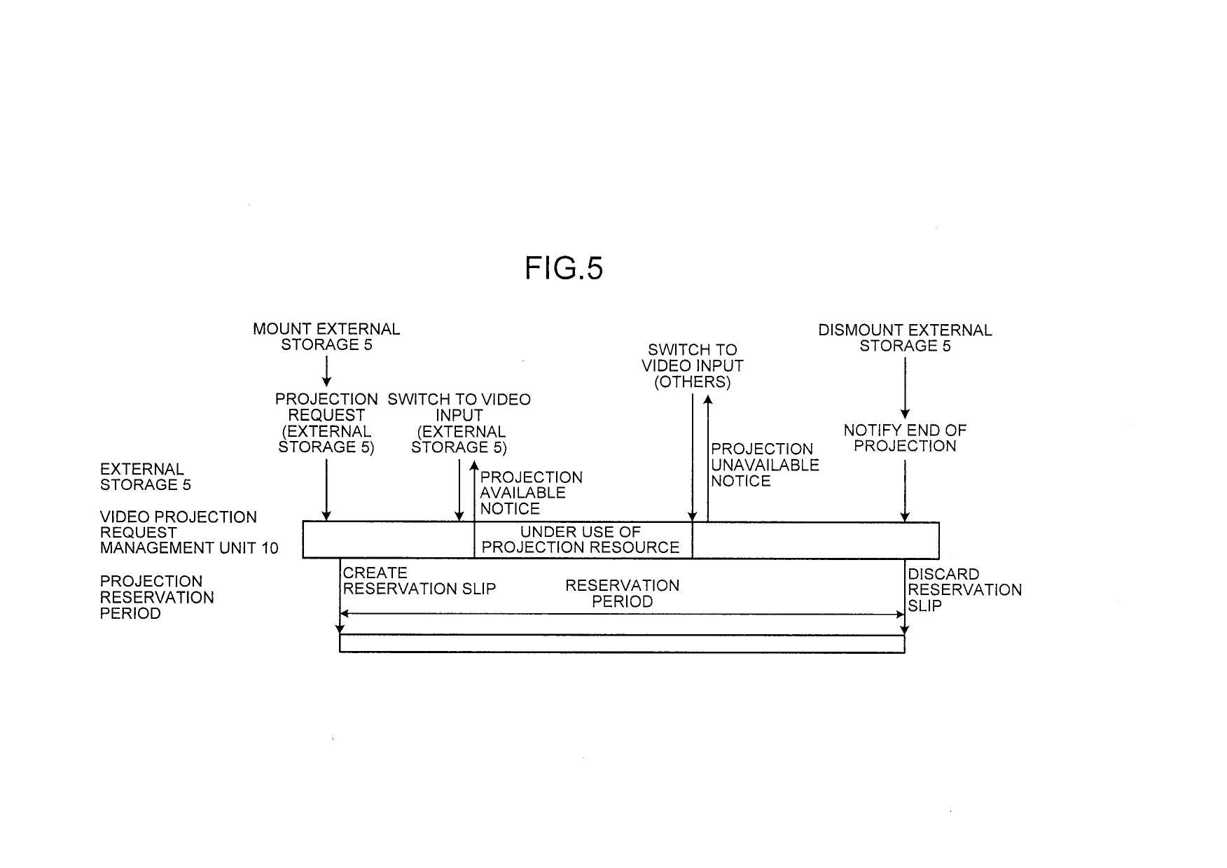

Next, by referring to FIG. 5, a life cycle of the above-described reservation slip will be described.

The life cycle of the reservation slip registered in the reservation table, i.e., a period from registration to discarding (deletion), differs by case, for example, the case of external storage file projection where the video output apparatus 4 or the external storage 5 is the input source, and the case of network projection where the PC 2 or 3 is the input source.

FIG. 5 is an explanatory diagram of the life cycle of the reservation slip of the external storage 5 illustrated in FIG. 1.

As illustrated in FIG. 5, when the external storage 5 is connected to the external storage input control unit 13, the projector 1 of FIG. 1 mounts the external storage 5, the external storage projection request management unit 12 sends a projection request to the video projection request management unit 10.

In the projector 1 of FIG. 1, the video projection request management unit 10 creates the reservation slips and registers them in the reservation table in the order according to a predetermined rule. Thus, the state enters a reservation start.

When the reservation is started, the video projection request management unit 10 receives a video input switching instruction made through a user's operation from the external storage projection request management unit 12, sends a projection available notice to the external storage projection request management unit 12 when the instruction indicates the reservation confirmation number of the external storage 5, and starts a projection of video data supplied from the external storage 5.

Even the video projection request management unit 10 receives another video input switching during projection of the video data supplied from the external storage 5 (i.e., during use of projection resource), the video projection request management unit 10 sends a projection unavailable notice and maintains the projection available state of the video data supplied from the external storage 5.

Next, when the external storage 5 is disconnected from the external storage projection request management unit 12 and dismounted, and a projection ending notice is received from the external storage projection request management unit 12, the video projection request management unit 10 discards the reservation slip from the reservation table.

Thus, in the case of the external storage file projection, time until the external storage 5 is dismounted after the reservation slip is created and registered into the reservation table is the reservation period and becomes the life cycle of the reservation slip.

Because the case similarly applies to the video output apparatus 4, the description thereof is not repeated.

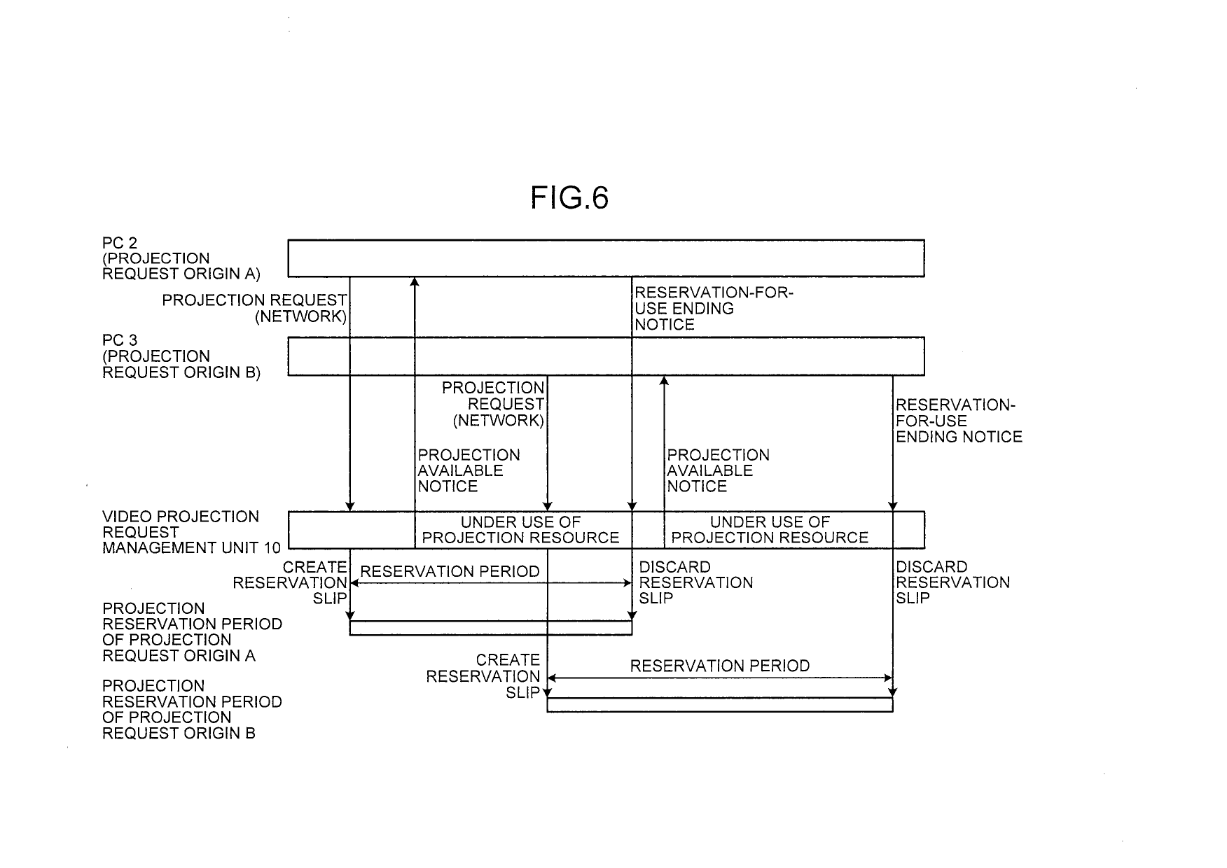

Next, by referring to FIG. 6, the life cycle of the reservation slip of the network projection will be described.

FIG. 6 is an explanatory diagram of the life cycle of each of the reservation slips of the PCs 2 and 3 illustrated in FIG. 1.

As illustrated in FIG. 6, in the projector 1 of FIG. 1, the video projection request management unit 10 creates a reservation slip when a projection request of the PC 2 (projection request origin A) is received from the network projection request management unit 14, and registers the reservation slip into the reservation table in the order according to a predetermined rule. Thus, the reservation of the PC 2 is started.

When the reservation is started, the video projection request management unit 10 receives a video input switching instruction from the network projection request management unit 14, sends a projection available notice to the network projection request management unit 14 when it comes the turn of the reservation confirmation number of the PC 2, and starts a projection of video data supplied from the network projection request management unit 14 to the PC 2.

The video projection request management unit 10 creates a reservation slip of the PC 3 when a projection request of the PC 3 (projection request origin B) is received from the network projection request management unit 14 after the reservation of the PC 2, is made, and registers the reservation slip into the reservation table in the order according to the predetermined rule. Thus, the reservation of the PC 3 is started.

However, at this point in time, because the projection of the PC 2 is under execution, a reservation of the projection of the PC 3 is awaited until the projection of the PC 2 ends.

When a reservation-for-use ending notice of the PC 2 is received from the network projection request management unit 14, the video projection request management unit 10 discards the reservation slip of the PC 2 from the reservation table, sends the projection available notice of the PC 3 to the network projection request management unit 14, and starts a projection of the video data of the PC 3 supplied from the network projection request management unit 14.

Then, the video projection request management unit 10 discards the reservation slip of the PC 3 from the reservation table when the reservation-for-use ending notice of the PC 3 is received from the network projection request management unit 14.

Thus, in the case of the network projection, time until the reservation-for-use ending notice is received after the reservation slip is created and registered into the reservation table is the reservation period and becomes the life cycle of the reservation slip.

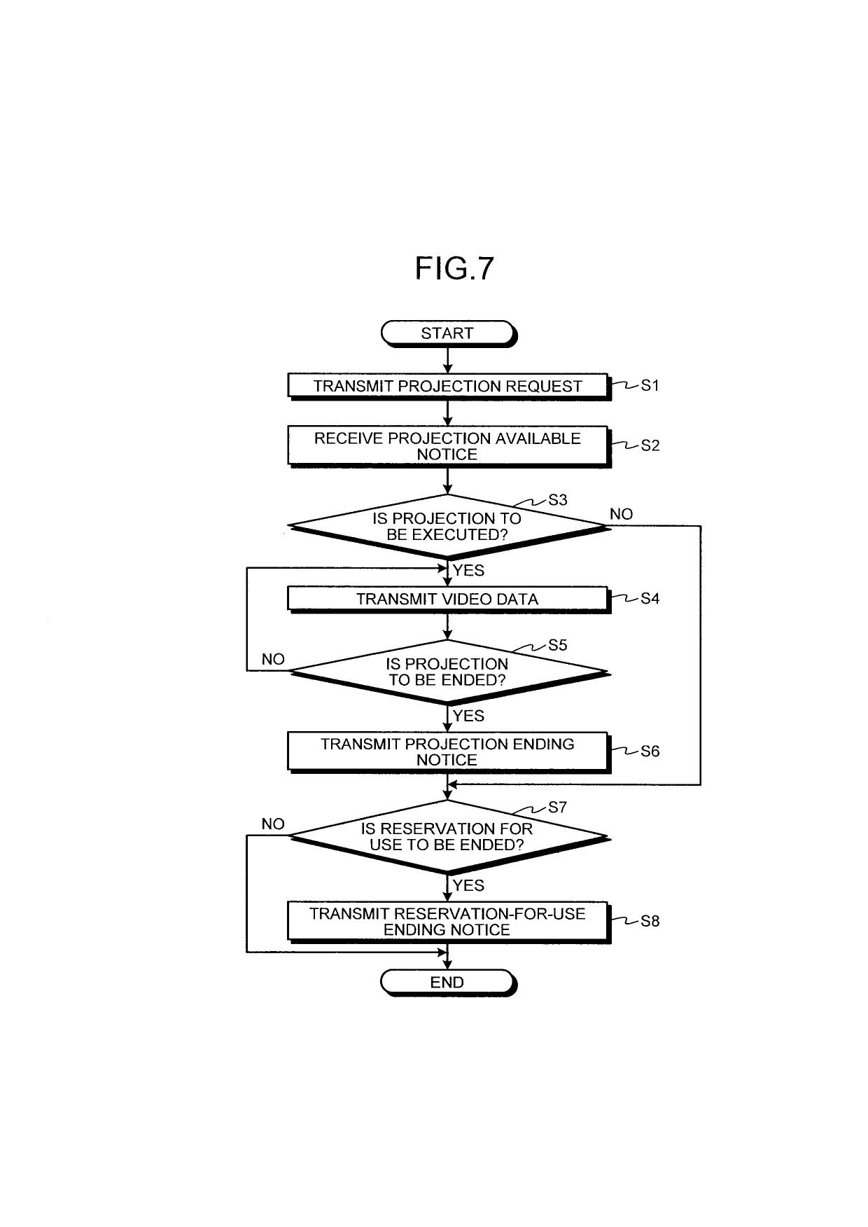

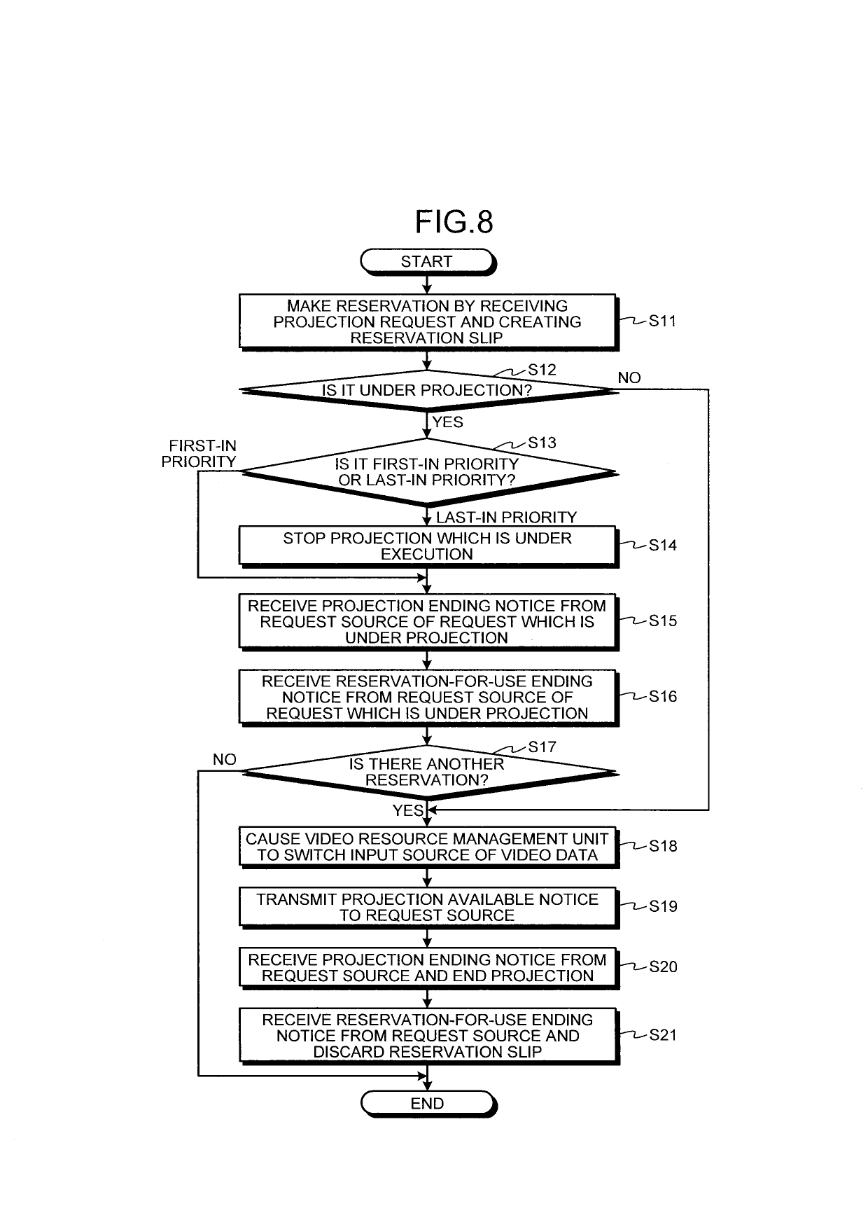

Next, by referring to FIGS. 7 and 8, an operation from start to end of the reservation executed by the PC 2 and the video projection request management unit 10 of the projector 1 will be described.

FIG. 7 is a flowchart illustrating an operation from start to end of the reservation that the PC 2 has made with respect to the projector 1 of FIG. 1.

When the user of the PC 2 performs an operational input to request a projection by the projector 1 with respect to the PC 2, and when the PC 2 detects the operational input, an operation of FIG. 7 starts.

The PC 2 of FIG. 1 transmits a projection request to the projector 1 in step S1 of FIG. 7. When a projection available notice is received from the projector 1 in step S2, the PC 2 determines whether to or not to perform the projection in step S3. When it is determined to perform the projection (the case of Yes), the process proceeds to step S4. On the other hand, when it is determined not to perform the projection (the case of No), the process proceeds to step S7.

In the determination of step S3, it is determined to perform the projection when there is an operational input to request the projection which is made by the user of the PC 2, whereas it is determined not to perform the projection when there is no operational input.

In step S4, video data is transmitted to the projector 1 and the process proceeds to step S5.

In this way, the PC 2 can make a reservation for projection with respect to the projector 1 and start the projection based on the notice from the projector 1, without asking the projector 1 repeatedly.

Next, it is determined whether to end the projection in step S5. When it is determined not to end (in the case of No), the process returns to step S4. On the other hand, when it is determined to end (in the case of Yes), the process proceeds to Step 6.

In the determination of step S5, it is determined not to end when there is no operational input to request the end of the projection which is made by the user of the PC 2, and it is determined to end when there is such an operational input.

In step S6, the projection ending notice is transmitted to the projector 1 and the process proceeds to step S7.

Step S6 corresponds to step S20 of FIG. 8.

It is determined whether to end a reservation for use in step S7. When it is determined to end (in the case of Yes), the process proceeds to step S8. That is, the reservation-for-use ending notice is transmitted and then the process ends. When it is determined not to end (in the case of No), the process ends immediately.

In the determination of step S7, it is determined not to end when there is no operational input to request the end of the reservation for use which is made by the user of the PC 2, and it is determined to end when there is such an operational input.

FIG. 8 is a flowchart illustrating an operation from start to end of a reservation of the PC 2 in the video projection request management unit 10 of the projector 1 of FIG. 1.

The video projection request management unit 10 receives a projection request and makes a reservation by creating a reservation slip in step S11.

The operation in step S11 corresponds to the operation in step S1 of FIG. 7.

Next, it is determined whether projection is being performed or not in step S12 of FIG. 8. When projection is being performed (in the case of Yes), the process proceeds to step S13. On the other hand, when projection is not being performed (in the case of No), the process proceeds to step S18.

In step S13, it is determined whether a first-in priority is used or a last-in priority is used.

The “last-in priority” means that a projection request received later during the projection has a priority for projection, and “first-in priority” means that a projection request which is under projection has a priority for projection.

In the determination of step S13, the video projection request management unit 10 checks with the video projection request management unit 10 for whether either the first-in priority or the last-in priority has been set beforehand. This setting can be set by the user beforehand.

The video projection request management unit 10 may determine the first-in priority when the first-in priority has been set, and may determine the last-in priority when the last-in priority has been set.

When the first-in priority has been determined in the determination of step S13, the process proceeds to step S15, and when the last-in priority has been determined, the process proceeds to step S14.

In Step 14, the projection which is under execution is stopped.

In step S14, the video projection request management unit 10 of FIG. 1 issues an instruction of stopping the projection with respect to the video projection stop control unit 11. That is, the video projection stop control unit 11 performs a control of causing the input source of the video data which is under projection to stop inputting the video data.

For example, in a case where the video data of the external storage 5 is being projected, the video projection stop control unit 11 issues a stop instruction to the external storage projection request management unit 12, and the external storage projection request management unit 12 causes the external storage input control unit 13 to stop reading the video data.

In addition, in a case where the video data of the video output apparatus 4 is being projected, the video projection stop control unit 11 issues a stop instruction to the video resource management unit 20, and the video resource management unit 20 stops the output of the video data to the video output apparatus 4 using the video data input control unit 18.

This is an operation of interrupting the operation (projection) under execution in order to perform the projection of the PC 2.

Next, the projection ending notice is received from the request source whose video data is being projected in step S15, the reservation-for-use ending notice is received from the request source whose video data is being projected in step S16, and the process proceeds to step S17.

In step S17, it is determined whether there is another reservation or not. When it is determined that there is another reservation (in the case of Yes), the process proceeds to step S18, and when it is determined that there is no reservation (in the case of No), the process ends.

Here, because there is a reservation made by the PC 2, the process proceeds to step S18.

In step S18, the video resource management unit 20 switches the input source of the video data, and the process proceeds to step S19.

In step S18, the video projection request management unit 10 causes the video resource management unit 20 to switch to the wired communication control unit 15 as the input source of the video data to be input to the video projection unit 21. Actually, the video data which has been input to the wired communication control unit 15 is input into the video resource management unit 20 via the network projection request management unit 14 and the video projection request management unit 10.

In step S19, the projection available notice is transmitted to the request source, and the process proceeds to step S20.

In step S19, the video projection request management unit 10 transmits the projection available notice to the PC 2 via the network projection request management unit 14 and the wired communication control unit 15.

In this way, the projector 1 can receive and project the video data supplied from the PC 2.

Next, in step S20, the projection ending notice is received from the request source, and the projection ends.

Step S20 corresponds to step S6 of FIG. 7.

In step S20, the video projection request management unit 10 receives the projection ending notice from the PC 2 via the network projection request management unit 14 and the wired communication control unit 15, and ends the projection of the video projection unit 21.

Next, in step S21, the reservation-for-use ending notice is received from the request source, the reservation slip is discarded, and then the process ends.

Step S21 corresponds to step S8 of FIG. 7.

In step S21, the video projection request management unit 10 receives the reservation-for-use ending notice from the PC 2 via the network projection request management unit 14 and the wired communication control unit 15, and discards the reservation slip of the PC 2 from the reservation table.

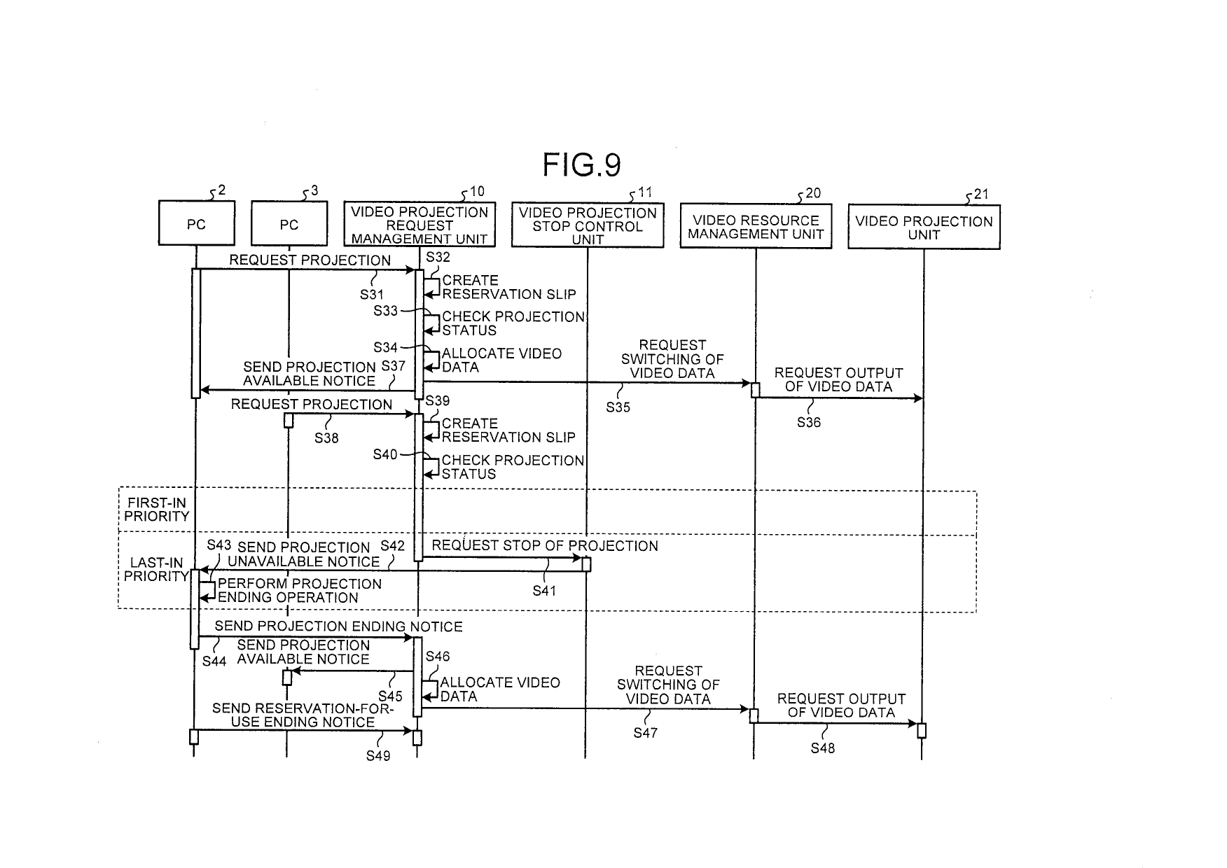

Next, by referring to FIG. 9, an operation is described in which, in a state where the projector 1 is projecting nothing, a projection request of the PC screen is received from the PC 2, another projection request of the PC screen of the PC 3 is received under the projection according to the projection request from the PC 2, and the projection is switched.

FIG. 9 is a diagram illustrating a sequence of a projection operation of the projector 1, the PC 2, and the PC 3 of FIG. 1.

When a projection request is received from the PC 2 (S31), the video projection request management unit 10 creates a reservation slip (S32), checks a projection status (S33), allocates, here, video data (S34) when nothing is under projection, and sends a video data switching request to the video resource management unit 20 (S35). The video data switching request is an instruction for switching among the above-described input sources.

The video resource management unit 20 switches to the wired communication control unit 15 which inputs the video data supplied from the PC 2 as the input source of the video data which is input to the video projection unit 21, and requests the video projection unit 21 to output the video data (S36).

The projection available notice is transmitted to the PC 2 (S37).

In this manner, the PC 2 can recognize that the projector 1 can perform projection, and can cause its PC screen to be projected by sending the video data to the projector 1.

Next, when a projection request is received from the PC 3 (S38), the video projection request management unit 10 creates a reservation slip (S39) and checks a projection status (S40). In this case, it is recognized that the projection of the PC screen of the PC 2 is under execution.

Here, the video projection request management unit 10 allows the projection of the PC screen of the PC 2 to be continued when the first-in priority is set, but sends a projection stop request to the video projection stop control unit 11 when the last-in priority is set (S41). Then, the video projection stop control unit 11 sends the projection unavailable notice to the PC 2 (S42). In this process, the video projection stop control unit 11 sends a projection unavailable notice to the network projection request management unit 14, and the network projection request management unit 14 sends a projection unavailable notice to the PC 2 via the wired communication control unit 15.

In the PC 2, when the projection unavailable notice is received, a projection ending operation is executed (S43). That is, the output of the video data is suspended and the projection ending notice is sent to the video projection request management unit 10 (S44).

When the projection ending notice is received from the PC 2, the video projection request management unit 10 sends the projection available notice to the PC 3 (S45), allocates the video data (S46), and sends the video data switching request to the video resource management unit 20 (S47). The video data switching request is an instruction for switching among the above-described input source.

The video resource management unit 20 changes the input source of the video data which is input to the video projection unit 21 to the wireless communication control unit 16 which inputs the video data supplied from the PC 3, and requests the video projection unit 21 to output the video data (S48).

Thus, in this case, the PC 3 can recognize that the projector 1 can perform the projection, and can cause its PC screen to be projected by sending the video data to the projector 1.

In addition, the video projection request management unit 10 discards the reservation slip of the PC 2 from the reservation table when the reservation-for-use ending notice is received from the PC 2 (S49).

Next, by referring to FIGS. 1, 4, and 10 through 14, an example is described in which each of the received projection requests is reserved in the order according to a predetermined rule, and the projection thereof is executed in the same order in the video projection request management unit 10.

First, as the projection requests are reserved in order of reception, each of the projection requests from the PCs 2 and 3, the video output apparatus 4, and the external storage 5 can be executed in the order of reception.

In the case of executing this process, the order according to the predetermined rule is set to an order in which the projection requests are received and a projection request subsequent to the projection request, the projection of which has ended, is to be executed; the video projection request management unit 10 of FIG. 1 functions as a unit that sends the projection available notice to the video input unit from which the projection request to be executed has been received and causes the video input unit to input video data.

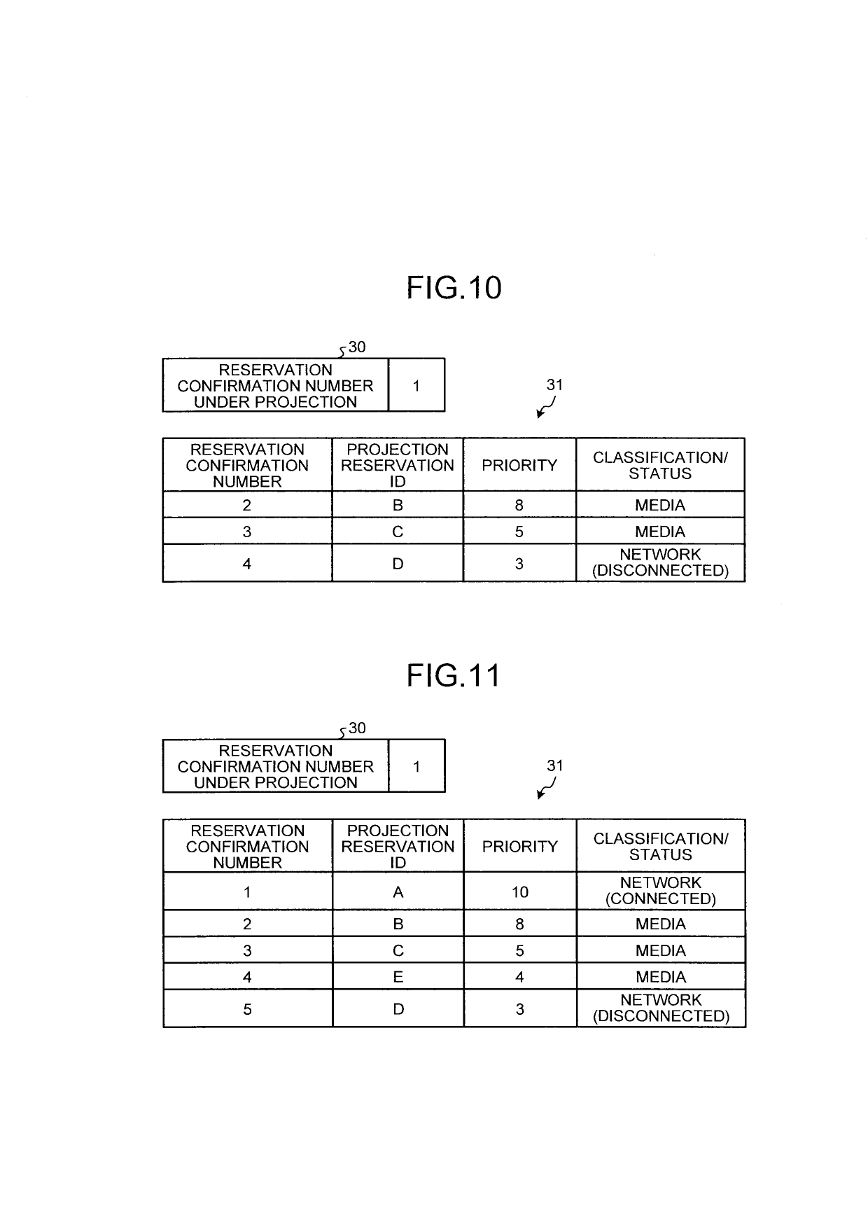

FIG. 10 is a diagram illustrating an example of the data contents of a reservation table retained by the video projection request management unit 10 of the projector 1 of FIG. 1.

For example, in the case of the contents of a field 31 of the reservation table illustrated in FIG. 4, the video projection request management unit 10 ends the projection of the reservation confirmation number “1” which is being currently projected, and moves forward each of the reservation confirmation numbers of the reservation slips which currently have the reservation confirmation numbers “2” through “4” by one when the projection reservation ID “A” of the reservation confirmation number “1” is discarded. As illustrated in the field 31 of FIG. 10, because the reservation confirmation number “1” is allocated to the reservation slip whose projection reservation ID is B, the projection is executed according to this reservation slip.

In this process, for example, when the PC 2 corresponds to the projection reservation ID “A” in FIG. 4, and when the video output apparatus 4 corresponds to the projection reservation ID “B”, the video projection request management unit 10 of the projector 1 notifies the video data input control unit 18, which is a request source of the projection request with a next high priority, of its turn of projection, when the projection of the PC 2 being currently processed is completed.

Because the video data input control unit 18 prompts the video output apparatus 4 to output the video data, the projection of the video based on the video data of the video output apparatus 4 can be started.

When this projection is completed, the projection of the projection request of the next turn in the reservation can be automatically started.

In this way, the reserved projection requests are processed in the order from the projection request which is reserved earlier.

Thus, by notifying the request source of the completion of the previous projection after the previously applied projection is completed, the network is effectively used and a plurality of projection requests is received, and then each projection can be started when each of the projection requests becomes able to be processed.

Next, projection of each of the projection requests of the PCs 2 and 3, the video output apparatus 4, and the external storage 5 can be executed according to a priority by reserving the projection requests into the reservation table in the order from the projection request with a high priority and the projection request with a low priority where the priority is given whenever the projection request is made.

The priority of this case may be determined such that, at the time of making the projection request, the request sources of the projection requests, which include the external storage projection request management unit 12, the network projection request management unit 14, and the video data input control units 17 to 19, may specify the priority at the time of making the projection request. Alternatively, the priority may be determined in a manner that the video projection request management unit 10 stores the priorities given beforehand to the external storage input control unit 13, the wired communication control unit 15, the wireless communication control unit 16, and the video data input control units 17 to 19, respectively.

In the case of executing this process, when the order according to the predetermined rule is the order of priority given to each projection request, that is, from a high priority to a low priority, and a new projection request of video data is received from the video input unit, the video projection request management unit 10 of FIG. 1 functions as a unit that causes the video input unit which is the input source of the video data being currently projected to continue to input the video data, causes the video input unit that is the input source of the video data under projection to stop inputting the video data when the projection request has a priority lower than the priority of the received new projection request, and causes the video resource management unit 20 to switch to the video input unit from which the new projection request has been received as the input source of the video data.

FIG. 11 is a diagram illustrating another example of the data contents of the reservation table retained by the video projection request management unit 10 of the projector 1 of FIG. 1.

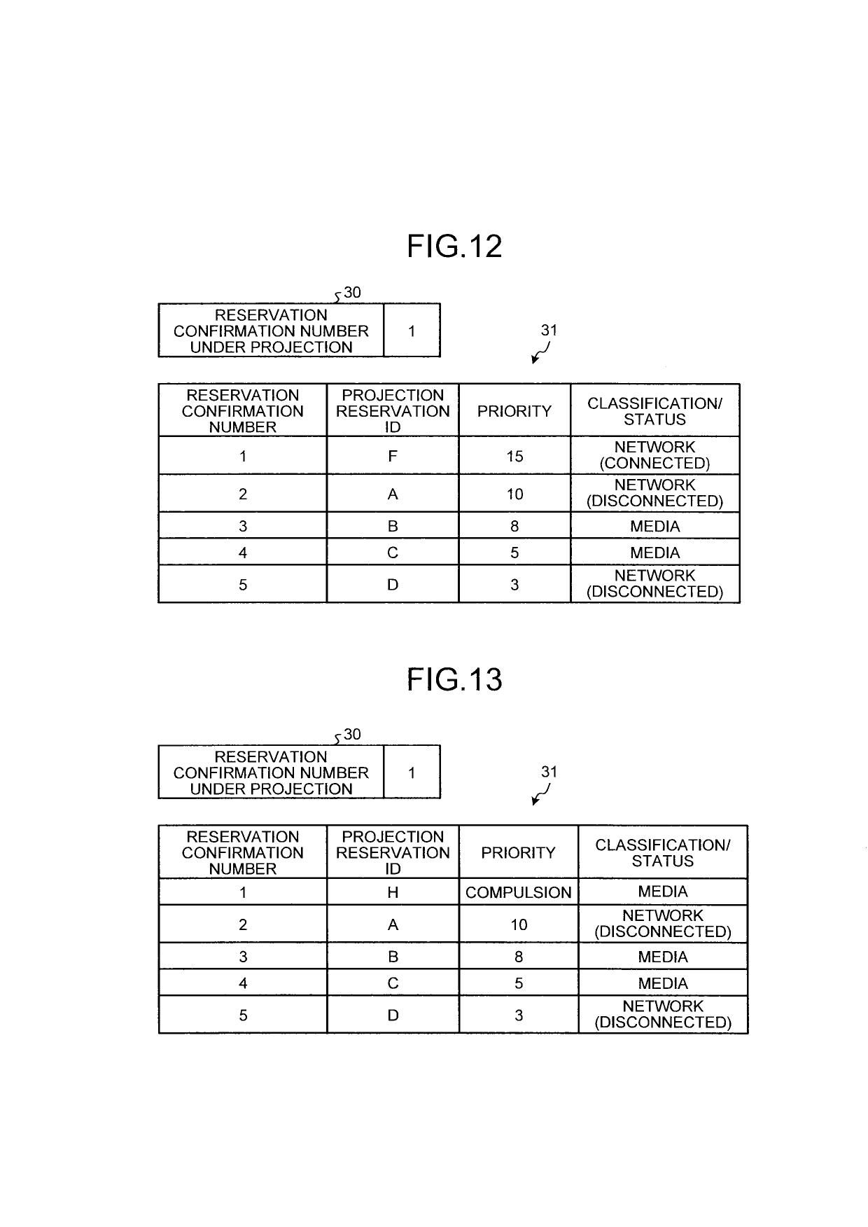

FIG. 12 is a diagram illustrating a further example of the data contents of the reservation table retained by the video projection request management unit 10 of the projector 1 of FIG. 1.

For example, in the case of the contents of a field 31 of the reservation table illustrated in FIG. 4, when the reservation slip of the projection reservation ID “E” with the priority “4” is created as the reservation slip of the new projection request, as illustrated in the field 31 of FIG. 11, the video projection request management unit 10 inserts the reservation slip in the next of the reservation slip of the projection reservation ID “C” with the priority “5” so that the reservation confirmation number becomes 4, and moves back the reservation confirmation number of the reservation slip of the projection reservation ID “D” with the priority “3” by one so that the reservation confirmation number becomes 5.

In this case, the projection of the reservation slip of the projection reservation ID “A” with the priority “10” is made to continue. In addition, although the reservation slip of the projection reservation ID “E” with the priority “4” was reserved later than the reservation slip of the projection reservation ID “D” with the priority “3”, it can be projected earlier.

In addition, for example, in the case of the contents of the reservation table illustrated in FIG. 4, when the reservation slip of the projection reservation ID “F” with the priority “15” is created as the reservation slip of a new projection request, as illustrated in the field 31 of FIG. 12, the video projection request management unit 10 registers 1 as the reservation confirmation number of the reservation slip of the projection reservation ID “F” with the priority “15”, and moves back the number of each of the reservation slips which have been registered beforehand by one.

For example, in a case where the reservation slip of the projection reservation ID “A” with the priority “10” is the reservation slip of the projection request that the wired communication control unit 15 has received from the PC 2, the video projection stop control unit 11 of the video projection request management unit 10 stops the input of the video data from the PC 2 via the network projection request management unit 14 and the wired communication control unit 15.

On the other hand, in a case where the reservation slip of the projection reservation ID “F” with the priority “15” is the reservation slip of the projection request which has been received from the PC 3 via the wireless communication control unit 16, the video projection request management unit 10 causes the video resource management unit 20 to switch to the wireless communication control unit 16 as the input source of the video data to be input to the video projection unit 21.

In this way, the projection of the PC 2 is ended and the projection of the PC 3 is started.

Thus, when a projection request with a priority lower than the priority of the reservation slip whose projection is under execution is made, the projection request is first reserved instead of being executed immediately, and is then executed after the reservations with higher priorities are completely processed. In addition, when the projection request with a priority higher than the priority of the reservation slip whose projection is under execution is made, the operation which is under projection at that time is stopped and then the projection of the input request is immediately started.

Next, when the priority of a projection request is “compulsion”, the projection is performed by placing the highest priority to the projection request specified as “compulsion” regardless of the reservation status of the current projection request.

In the case of executing this operation, the video projection request management unit 10 of FIG. 1 functions as a unit that, when a compulsory projection request of video data has been received from the video input unit, causes the video input unit which is the input source of the video data under projection to stop inputting the video data, and causes the video switching unit to switch to the video input unit from which the compulsory projection request has been received, as the input source of the video data.

FIG. 13 is a diagram illustrating a yet further example of the data contents of the reservation table retained by the video projection request management unit 10 of the projector 1 of FIG. 1.

For example, in the case of the contents of the field 31 of the reservation table illustrated in FIG. 4, when a reservation slip of the projection reservation ID “H” with the priority “compulsion” is created as a reservation slip of a new projection request, as illustrated in the field 31 of FIG. 13, the video projection request management unit 10 inserts the reservation slip of the projection reservation ID “H” with the priority “compulsion” into the reservation confirmation number “1”, and moves back the reservation confirmation numbers of the other reservation slips by one.

In this case, the projection of the reservation slip of the projection reservation ID “A” with the priority “10” which has been under projection is stopped, and the projection of the reservation slip of the projection reservation ID “H” with the priority “compulsion” is executed.

In this way, the request origin can execute its projection as the top priority without caring about the reservation status of the projection by placing the priority “compulsion” to its projection request.

The projection request with the priority “compulsion” may be specified by the request origin of the projection request at the time of making the projection request, or may be determined beforehand by giving a priority to every video input unit.

Next, an operation performed when input of the video data under projection is interrupted due to some causes, such as network disconnection and reading failure is described.

In a case where the input of the video data being projected is interrupted, the projection of the reservation slip of the following reservation confirmation number reserved in the reservation table is executed.

In the case of executing this operation, the video projection request management unit 10 of FIG. 1 functions as a unit that, when the input of the video data to the video input unit, by which the video data which is being projected by the video projection unit is input, is interrupted, causes the video input unit, which is the input source of the video data under projection, to stop inputting the video data, and causes the video switching unit to switch to the video input unit from which a projection request subsequent to the projection request of the video data whose input has been interrupted has been received, as the input source of the video data.

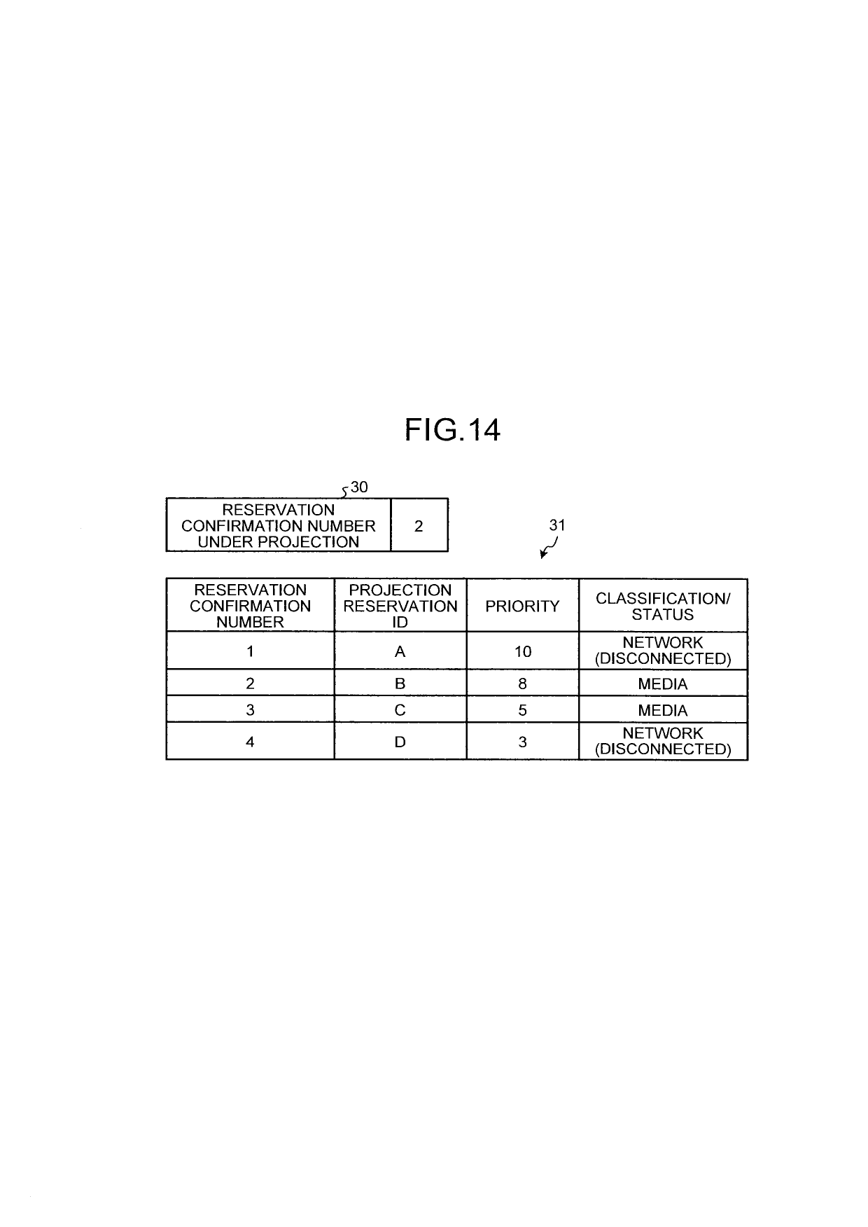

FIG. 14 is a diagram illustrating a yet further example of the data contents of the reservation table retained by the video projection request management unit 10 of the projector 1 of FIG. 1.

For example, in the case of the contents of the field 31 of the reservation table illustrated in FIG. 4, when the input of the video data which is under projection with the projection reservation ID “A” is interrupted, for example, due to the network disconnection, as illustrated in the field 31 of FIG. 14, the video projection request management unit 10 records information indicating that the network is not connected into the field of the classification/status of the reservation slip of the projection reservation ID “A” of the reservation confirmation number “1”, starts the projection of the projection reservation ID “B” of the reservation confirmation number “2”, and changes the confirmation number, in the field 30, of the video data which is under projection to “2.”

In this way, for example, during the execution of projection of the PC 2 which is connected via the LAN 6, when the network of the LAN 6 is disconnected and the input of the video data from the PC 2 is interrupted, the input is switched to an input signal of a next high priority among projectable input signals. Accordingly, the time of the situation where the output resource is not used can be minimized so that the output resource can be used effectively.

Next, an operation performed when the input is resumed after the input of the video data under projection has been interrupted due to some causes, such as network disconnection and reading failure, is described.

In a case where the input is resumed after the input of the video data under projection has been interrupted, a substitute projection is stopped and the projection of the video data which is input again is performed.

In the case of executing this operation, the video projection request management unit 10 of FIG. 1 functions as a unit that, when the input of the video data which has been interrupted is resumed, causes the above-mentioned video input unit, which is the input source of the video data under projection, to stop inputting the video data, and causes the video switching unit to switch to the video input unit from which the projection request of the video data which has been interrupted has been received, as the input source of the video data.

When the input of the video data of the projection reservation ID “A” which was under projection is resumed after the operation of the above-described case where the input of the video data was interrupted, as illustrated in FIG. 4, the video projection request management unit 10 changes the information in the field of the classification/status of the reservation slip of the projection reservation ID “A” of the reservation confirmation number “1” into information that the network is connected, and interrupts or stops the projection of the projection reservation ID “B” of the reservation confirmation number “2”.

In this way, at the time of resuming the network connection, the projection which has been under execution may be interrupted, or may be stopped.

Thereafter, the projection of the projection reservation ID “A” of the reservation confirmation number “1” is resumed, and the reservation confirmation number, which is under projection, in the field 30 is replaced with “1.”

In this way, for example, when the input of the video data from the PC 2 is interrupted due to the network disconnection of the LAN 6 during the execution of the projection of the PC 2 connected via the LAN 6, and after that, the input is resumed, the projection thereof is automatically resumed. Thus, the input signal which is interrupted due to the network disconnection can be automatically resumed, without bothering the user.

When the priority of the request which has been under projection at the time of resuming the network connection is “compulsion”, the projection may be continued by placing the highest priority to the projection of the priority “compulsion”, or placing the highest priority to the projection request which becomes able to be projected as the network is recovered.

Next, when an upper limit is provided in the number of requests in the above-described reservation table, an operation performed when the projection requests exceed the upper limit in number is described.

First, when the number of requests of the reservation table exceeds the upper limit, it is preferable to refuse reception of a new projection request.

In the case of executing this operation, the video projection request management unit 10 of FIG. 1 functions as a unit that, when there is a new projection request, refuses reception of a new projection request when the number of projection requests will exceed a predetermined upper limit if a reservation of the projection request is made.

The upper limit of the number of requests in the reservation table is set in advance, and is stored in the video projection request management unit 10.

When there is a new projection request, when a reservation slip of the new projection request is reserved to be included in the numbers of requests of the reservation table, the video projection request management unit 10 determines whether the number of requests exceeds the upper limit, receives the reservation when not exceeding, but does not receive and discards the reservation when exceeding.

Thus, the situation of canceling execution of the reserved projections which have been already received is avoidable by not receiving a new projection request when there is the new projection request.

Secondly, when the number of requests of the reservation table exceeds the upper limit, it is preferable to determine whether to receive or not to receive a new projection request, based on the priority.

In the case of executing this operation, the video projection request management unit 10 of FIG. 1 functions as a unit that, when there is a new projection request and the number of projection reservations will exceed the upper limit if the projection request is reserved, discards a reservation with a priority lower than the priority of the new projection request among each of the projection requests which have been reserved beforehand, and reserves a reservation slip of the new projection request.

When there is a new projection request, the video projection request management unit 10 compares the priority of each of the reservation slips reserved in the reservation table with the priority of the new projection request, and refuses to receive the new projection request when the priority of the new projection request is the lowest. In addition, when there are some projection requests with a priority lower than the priority of the new projection request in the reservation slips reserved in the reservation table, the reservation slip with the lowest priority is discarded, and the reservation slip of the new projection request is reserved.

Thus, when there has been a new projection request, a projection reservation group managed by the projector 1 and the new projection request are compared with each other, and the projection request with the lowest priority is discarded. In this way, it is possible to receive the projection request in view of a priority.

Although description of the embodiments has been made here, in the invention, the specific configuration of each unit, the contents of each process, the format of data, and the like are not limited to the description of the embodiment.

The above-mentioned embodiment has described in connection with an example where the invention is applied to a video projection apparatus.

However, the invention is applicable to arbitrary information processing apparatuses as long as they have a projecting function.

Moreover, the configurations of the embodiment which have been described above may be combined arbitrarily unless those are mutually contradictory.

According to the present invention, a plurality of projection requests is accand can start a projection of each projection request when the projection apparatus enters a state in which it is capable of performing the projection of the corresponding projection request.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A video projection apparatus comprising:
a plurality of video input units;
a video projection unit that projects video based on video data input from each of the plurality of video input units on a projection surface thereof;
a video switching unit that switches to any one of the video input units as an input source of video data to be input to the video projection unit; and
a video switching control unit that
receives a projection request of the video data input from each of the video input units,
reserves projection of each of the received projection requests in an order according to a predetermined rule, and
causes the video switching unit to sequentially switch among the video input units, which respectively correspond to the received projection requests, as the input source in the order.

2. The video projection apparatus according to claim 1, wherein
the order according to the predetermined rule is an order in which the projection requests are received, and
the video switching control unit includes a unit that
sends a projection available notice to the video input unit from which the projection request to be executed has been received, and
causes the video input unit to input video data when projection of a projection request subsequent to the projection request, projection of which has ended, is to be executed.

3. The video projection apparatus according to claim 1, wherein
the order according to the predetermined rule is an order of priority given to each projection request, from a higher priority to a lower priority, and
the video switching control unit includes a unit that, when a new projection request of video data is received from the video input unit, causes the video input unit, which is an input source of video data being currently projected, to continue to input the video data if a projection request of the currently projected video data has a priority higher than a priority of the received new projection request, but causes the video input unit, which is the input source of the video data being currently-projected, to stop inputting the video data and then causes the video switching unit to switch to the video input unit from which the new projection request has been received if the projection request of the currently projected video data has a priority lower than the priority of the received new projection request.

4. The video projection apparatus according to claim 1, wherein
the video switching control unit includes a unit that, when a compulsory projection request of video data is received from the video input unit,
causes the video input unit, which is an input source of video data being currently projected, to stop inputting the video data, and
causes the video switching unit to switch to the video input unit from which the compulsory projection request has been received.

5. The video projection apparatus according to claim 1, wherein
the video switching control unit includes a unit that, when input of video data to the video input unit, which is an input source of video data being currently projected, is interrupted,
causes the video input unit, which is the input source of video data being currently projected, to stop inputting the video data, and
causes the video switching unit to switch to the video input unit from which a projection request subsequent to the projection request of the video data whose input has been interrupted is received.

6. The video projection apparatus according to claim 5, wherein
the video switching control unit includes a unit that, when the input of the interrupted video data is resumed,
causes the video input unit, which is the input source of video data being currently projected, to stop inputting the video data, and
causes the video switching unit to switch to the video input unit which is the input source of the video data whose input is resumed.

7. The video projection apparatus according to claim 1, wherein
the video switching control unit includes a unit that, when there is a new projection request, refuses reception of the new projection request when a number of projection reservations will exceed a predetermined upper limit if the new projection request is reserved.

8. The video projection apparatus according to claim 3, wherein
the video switching control unit includes a unit that, when there is a new projection request,
discards a reservation of projection of a projection request with a priority lower than a priority of the new projection request among the projection requests which have been reserved when a number of projection reservations will exceed a predetermined upper limit if the new projection request is reserved, and
reserves projection of the new projection request.
